(19) United States
(12) Patent Application Publication
(10) Pub. No.: US 2013/0233797 A1
(43) Pub. Date: Sep. 12, 2013

(54) METHODS FOR OSMOTIC CONCENTRATION OF HYPER SALINE STREAMS

(71) Applicant: GREAT SALT LAKE MINERALS CORPORATION, Overland Park, KS (US)

(72) Inventors: Tzahi Cath, Golden, CO (US); Corey Milne, Ogden, UT (US); Daniel K. Pannell, Overland Park, KS (US); Jerry Poe, Hutchinson, KS (US); Mark Reynolds, Clinton, UT (US)

(73) Assignee: GREAT SALT LAKE MINERALS CORPORATION, Overland Park, KS (US)

(21) Appl. No.: 13/791,555

(22) Filed: Mar. 8, 2013

Related U.S. Application Data
(60) Provisional application No. 61/608,990, filed on Mar. 9, 2012.

(51) Int. Cl. C02F 1/44

(52) U.S. Cl. CPC C02F 1/445
USPC 210/642; 210/188; 210/180

(57) ABSTRACT

A novel method of extracting minerals from an aqueous source, and an equipment system for carrying out this method, are provided. The method comprises feeding the aqueous source into the feed side of a forward osmosis device while simultaneously feeding a draw solution that includes an osmotic agent through the draw side of the forward osmosis device. The feed and draw sides are separated by a semi-permeable membrane that allows water to be drawn through the membrane to the draw side, thus yielding a concentrated stream from the feed side. The solids can then be separated from that stream and recovered for use.

### RELATED APPLICATIONS

This application claims the priority benefit of a U.S. provisional application entitled, METHODS FOR OSMOTIC CONCENTRATION OF HYPER SALINE STREAMS, Ser. No. 61/608,990, filed Mar. 9, 2012, incorporated by reference herein.

### BACKGROUND OF THE INVENTION

1. Field of the Invention

The present invention is broadly concerned with liquid-treatment methods, and particularly methods usable for producing concentrated stream or otherwise useful hypersaline brines from a source of non-potable or otherwise impaired water.

2. Description of the Prior Art

As the demand for minerals and salts has grown, industry has long sought processes for further concentration and harvesting of salts from saline water, such as seawater, lake water, or brackish ground water. Some processes that have been used to desalinate and concentrate water are distillation, crystallization, and membrane processes, such as reverse osmosis, nanofiltration, and electrodialysis. Natural or enhanced evaporation in ponds is also being used for concentrating and harvesting of minerals and salts.

Water removal rate is a major economic parameter of mineral recovery and production. However, this parameter is typically limited in existing processes. For example, open ponds are strongly affected by weather and climate. In addition to limited water removal rate, another drawback for some of these processes is that some might consider them to be energy-intensive. Membrane-based systems can suffer additional problems. For example, membrane fouling and scaling in pressure-driven membrane processes (e.g., in reverse osmosis and nanofiltration) are often a major area of concern, as they can increase the cost of operating and maintaining the systems. Pretreatment of the feed water is a way of reducing fouling and scaling, but is typically expensive and requires additional steps. An additional drawback of most membrane-based systems is that increased salt content of the feed stream typically reduces the throughput of water across the membrane due to the lower water activity (high osmotic pressure) of the feed solution, or otherwise low or no driving force for mass transport across the membrane.

Open evaporation ponds are commonly used to concentrate saline and hypersaline water to supply the growing demand for minerals and other beneficial salts or soluble materials. However, a limited supply of land resources, environmental constraints, high energy-demand, and long natural evaporation time limit the rate of mineral separation and harvesting.

### SUMMARY OF THE INVENTION

The present invention overcomes the prior art deficiencies by providing a method of recovering solids from an aqueous source. The method comprises providing a forward osmosis unit comprising: a feed chamber having an inlet and an outlet; a draw chamber having an inlet and an outlet; and a semipermeable membrane positioned between the feed and draw chambers. The membrane has a permeate side in communication with the draw chamber, and a feed side in communication with the feed chamber.

The method comprises passing a source water through the feed chamber and a draw solution through the draw chamber. The passing causes water from the source water to be drawn through the membrane and into the draw solution, so that a concentrated source water exits from the feed chamber outlet and a diluted draw solution exits from the draw chamber outlet. Finally, one or more of the following is carried out: (a) recovering solids from the concentrated water source; (b) extracting energy from the concentrated water source; and (c) returning the diluted draw solution for reuse as a draw solution.

In another embodiment, the invention provides a solids recovery system. The solids recovery system comprises a forward osmosis unit comprising: a feed chamber having an inlet and an outlet; a draw chamber having an inlet and an outlet; and a semipermeable membrane positioned between the feed and draw chambers. The membrane has a permeate side in communication with the draw chamber, and a feed side in communication with the feed chamber. The system also comprises a source water source in communication with the feed chamber inlet, a draw solution source in communication with the draw chamber inlet; an evaporation reservoir in communication with the draw chamber outlet; and a solids separation device in communication with the feed chamber outlet.

### BRIEF DESCRIPTION OF THE DRAWINGS

FIG. 1 is a schematic hydraulic diagram of a source water concentration system according to one embodiment of the invention;

FIG. 2 is a schematic hydraulic diagram of a source water concentration system according to one embodiment of the invention;

FIG. 3 is a schematic hydraulic diagram of a source water concentration system according to one embodiment of the invention;

FIG. 4 is a schematic hydraulic diagram of a source water concentration system according to one embodiment of the invention;

FIG. 5 contains graphs showing water flux as a function of time for experiments conducted with the HTI-CTA membrane at 10° C., 20° C., and 40° C., and initial feed volumes of 6 L;

FIG. 6 displays graphs showing water flux as a function of concentration factor for experiments conducted with the HTI-CTA membrane at 10° C. and 20° C., and initial feed volumes of 6 L;

FIG. 7 shows graphs of water flux as a function of time and concentration factor for experiments conducted with the HTI-CTA membrane at 10° C., 20° C., and 40° C., initial feed volumes of 6 L, and initial draw solution volumes of 3 L;

FIG. 8 contains graphs showing water flux as a function of time and concentration factor for experiments conducted with the HTI-CTA membrane at 10° C., 20° C., and 40° C., initial feed volumes of 6 L, initial draw solution volumes of 3 L, and turbulence enhance spacers in flow channels;

FIG. 9 shows graphs of water flux as a function of time and concentration factor for experiments conducted with the OASYS-TFC membrane at 20° C., and initial feed volumes of 6 L; and

FIG. 10 displays graphs showing water flux as a function of time and concentration factor for experiments conducted with the OASYS-TFC membrane at 10° C.

### DETAILED DESCRIPTION OF THE PREFERRED EMBODIMENTS

### Terms

The following terms are used herein:

“Seawater” (abbreviated “SW”) is saline water from the sea or from any source of brackish water.

“Source water” is water, such as brackish water, impaired water, wastewater, chemical processing streams, sea water, lake water, solar pond water, or reservoir water, input to a treatment process, such as a desalination or concentration process.

“Hypersaline water” is a supersaturated brine stream used to draw water across a semipermeable membrane due to diffusion from a source water during a forward-osmosis process.

“Impaired Water” is any water that does not meet potable water quality standards.

“Concentrate” is a by-product of a water treatment processes having a higher concentration of a solute or other material than the feed water, such as a brine by-product produced by a desalination or a concentration process.

“Draw solution” is a solution having a relatively high osmotic potential that can be used to extract water from a solution having a relatively low osmotic potential. In certain embodiments, the draw solution may be formed by dissolving an osmotic agent in the draw solution.

“Receiving stream” is a stream that receives water by a water purification or extraction process. For example, in forward-osmosis, the draw solution is a receiving stream that receives water from a feed stream of water having a lower osmotic potential than the receiving stream.

“Solar pond” is a natural or engineered, salinity gradient pond having a higher salt concentration layer at the bottom of the pond and lower salt concentration layer on the top. In a solar pond, heat is captured at the bottom of the pond, and therefore, the temperature of the water at the bottom of the pond is much higher than the temperature of the water at the top of the pond.

“Hypersaline evaporation reservoir” is an evaporation pond in which the water is supersaturated, and precipitated minerals may have settled at the bottom of the reservoir.

“Upstream” and “downstream” are used herein to denote, as applicable, the position of a particular component, in a hydraulic sense, relative to another component. For example, a component located upstream of a second component is located so as to be contacted by a hydraulic stream (flowing in a conduit, for example) before the second component is contacted by the hydraulic stream. Conversely, a component located downstream of a second component is located so as to be contacted by a hydraulic stream after the second component is contacted by the hydraulic stream.

### Forward Osmosis

A forward-osmosis process is termed “osmosis” or “direct osmosis.” Forward osmosis typically uses a semipermeable membrane having a permeate side and a feed side. The feed (active) side contacts the water (source or feed water) to be treated. The permeate (support) side contacts a hypertonic solution, referred to as an osmotic agent, or draw solution, or receiving stream, that serves to draw (by osmosis or a combination of osmosis and convective flow by hydraulic pressure) water molecules and certain solutes and other compounds from the feed water through the membrane into the draw solution. The draw solution is circulated (or flowing) on the permeate side of the membrane as the feed water is passed by along the feed side of the membrane. Unlike reverse osmosis, which uses a pressure differential across a semipermeable membrane to induce mass-transfer across the membrane from the feed side to the permeate side, forward osmosis uses an osmotic-pressure difference (or water activity difference) between the feed stream and draw solution as the driving force for mass transfer across the membrane. As long as the osmotic pressure of water on the permeate side (draw solution side) of the membrane is higher (i.e., water activity is lower) than the osmotic pressure of water on the feed side, water will diffuse from the feed side through the membrane and thereby dilute the draw solution. To maintain its effectiveness in the face of this dilution, the draw solution is typically re-concentrated, or otherwise replenished, during use. This re-concentration typically consumes most of the energy that conventionally must be provided to conduct a forward-osmosis process. In particular implementations, the feed water is concentrated and the draw solution is ultimately diluted and discharged or further processed.

Because the semipermeable membranes used in forward-osmosis processes are typically similar to the membranes used in reverse osmosis, most contaminants are rejected by the membrane, and only water and some small ions or molecules diffuse through the membrane to the draw solution side. A contaminant that is “rejected” is prevented by the membrane from passing through the membrane. Selecting an appropriate membrane usually involves choosing a membrane that exhibits high rejection of salts as well as various organic and/or inorganic compounds while still allowing a high flux (throughput) of water through the membrane at a high or low osmotic driving force.

Other advantages of the forward-osmosis process can include relatively low propensity to membrane fouling, low energy consumption, simplicity, and reliability. Because the operating hydraulic pressures in a forward-osmosis process typically are very low (up to a few bars, reflective of the flow resistance exhibited in the flow channels of a membranes module or element), the equipment used for performing forward osmosis can be very simple. Also, use of lower pressure may alleviate potential problems with membrane support in the housing and reduce pressure-mediated fouling of the membrane.

### Forward Osmosis Concentration of Hypersaline Brines

With a suitable forward-osmosis semipermeable membrane, a relatively high water flux can be realized, and the feed stream can be substantially concentrated. For example, a draw solution having a solute concentration ten times that of seawater can produce flux of at least 5 Liter/(m²·hr) of clean water through the suitable forward-osmosis membrane into the draw solution from a stream having a solute concentration five times that of seawater. Thus, using forward osmosis, saline water can be further concentrated even to above its solutes saturation concentrations using hypersaline water as the draw solution and correspondingly reducing the energy required to concentrate the saline feed stream. The concentrated brine produced may be used as a draw solution in downstream purification processes or as the feed stream to mineral recovery systems.

### First Embodiment of the Invention

A first embodiment of the invention includes one or more forward-osmosis treatment stages to increase source water salinity. In the process a concentration step is performed in which the source water is concentrated by drawing water from the source water into a hypersaline stream that in the process is becoming diluted. The hypersaline draw solution stream is supplied by a hypersaline end stream of evaporation ponds, industrial byproduct brine, or any hypersaline, impaired water, for example. Although generally described in these exemplary systems for use in concentration of salt water, the methods and systems described in the exemplary embodiments may be applied to other source liquids.

An apparatus 100-1 for performing the process is shown in FIG. 1 and includes the following components: a source water reservoir 101, an upstream forward-osmosis unit 103 comprising a forward-osmosis membrane 153, a pump 135, a pretreatment unit 137, a source water feed stream 105, a hypersaline feed stream 109, a downstream solid separation unit 104, a downstream energy recovery system 145, and a hypersaline evaporation reservoir 102.

The source water unit 101 and upstream forward-osmosis unit 103 collectively provide a water stream that may be used to provide make-up water or start-up water to the hypersaline evaporation reservoir 102. The evaporation reservoir 102 can be, for example, a natural evaporation pond, an enhanced evaporation pond, a crystallizer device, or any other suitable device.

The energy-recovery system 145 can include a heat-exchanger, such as condensers, shell and tube heat exchangers, plate heat exchangers, circulators, radiators, and boilers (which may be parallel flow, cross flow, or counter flow heat exchangers), a power exchanger, or other suitable device that extracts usable energy from liquid entering it. The energy-recovery system 145 can be a combination of these exemplary devices as required or desired.

Source water (or other make-up water, termed generally “source water” here) 105 is drawn from an appropriate source and passes through the pretreatment unit 137. The pretreatment unit 137 pretreats the source water, as required, such as subjecting it to one or more processes including those selected from the group consisting of coagulation, media filtration, microfiltration, ultrafiltration, beach wells, ion-exchange, chemical addition, disinfection, and other membrane process, in any suitable order. The effluent 155 from the pretreatment unit 137 enters the upstream forward-osmosis unit 103.

As the make-up water 155 after pretreatment passes through the upstream forward-osmosis unit 103 on the feed side of the forward osmosis membrane 153, hypersaline water 109 from a hypersaline evaporation reservoir 102 flows through the upstream forward-osmosis unit 103 on the receiving side of the forward osmosis membrane 153. The hypersaline solution 109 could be any type of draw solution, such as a strong electrolyte solution. The solution will include an osmotic agent, with preferred osmotic agents including those selected from the group consisting of sulfate salts, chloride salts, and mixtures thereof.

As a result of the foregoing, the make-up source water 105 is concentrated by transfer of water (as indicated by the “W” arrow in FIG. 1) to the draw solution hypersaline water 109 through the forward osmosis membrane 153. Preferably, the flux of the water across the membrane is from about 1 L/m²-hr to about 15 L/m²-hr, more preferably from about 3 L/m²-hr to about 15 L/m²-hr, and even more preferably from about 10 L/m²-hr to about 15 L/m²-hr. The treated source water 155 is concentrated to produce a concentrate stream 106, and the hypersaline water 109 becomes a diluted stream 110. The diluted hypersaline water stream 110 exiting the upstream forward-osmosis unit 103 is transferred through a conduit 120 into the source water reservoir 101, or returned to the hypersaline water reservoir 102 through conduit 130.

The concentrated source water 106 may be subjected to further purification steps. It may contain precipitated minerals or other solid materials that precipitated during the concentration step in the forward osmosis unit 103. The concentrated stream 106 enters a solid separation unit 104 in which solids are separated and recovered. The solid separation unit 104 can be, for example, a gravity clarifier, hydrocycione, filtration device, settling pond, solar evaporation pond, evaporative crystallizer tank, vacuum-cooled crystallizer tank, or any other solid separation devices or combination of devices. The clarified concentrated source water 107 may further flow through an energy recovery unit 145 to extract any type of energy from the concentrated stream 107. The concentrated source water 107 after energy recovery 145, now concentrated with valuable solutes, flows into the hypersaline evaporation reservoir 102 for further concentration through natural evaporation or engineered enhanced evaporation processes. Concentrated hypersaline 115 from the evaporation reservoir is drawn and further processed on- or off-site for harvesting and extracting of useful products (e.g., water soluble salts).

The solid stream 116 exiting the solid separation unit 104 can be harvested for beneficial use or for disposal.

Because forward-osmosis membranes and processes generally exhibit a low degree of fouling and scaling, forward-osmosis can be advantageously used in this embodiment for concentrating almost any source water or impaired water for use in most downstream processes. This can eliminate other, more expensive, concentration steps as well as protect the concentration process in the evaporation reservoir by reducing precipitation of undesirable minerals and solids at the bottom of the reservoir.

Although in this embodiment the forward-osmosis system 103 is depicted and described as a “one-stage” forward-osmosis system, it will be understood that this forward-osmosis system alternatively can include only one forward-osmosis unit or can include more than one forward-osmosis units. In addition, even though the forward-osmosis system 103 is shown and described with a single forward-osmosis unit in tandem (in series) with the process, it will be understood that other interconnection schemes (including parallel connection schemes and/or combinations of parallel and series) can be used.

Another potential advantage of this embodiment is that source water can be more rapidly concentrated to become a hypersaline water before further processing to recover useful materials from the hypersaline water.

It will be understood that this embodiment can be used for purposes other than concentration of source water to become hypersaline water. The disclosed embodiment may be used in the treatment of landfill leachates. The disclosed embodiment can also be used in the food industry or in feed solutions as used in the chemical industry, pharmaceutical industry, or biotechnological industry.

### Second Embodiment According to the Invention

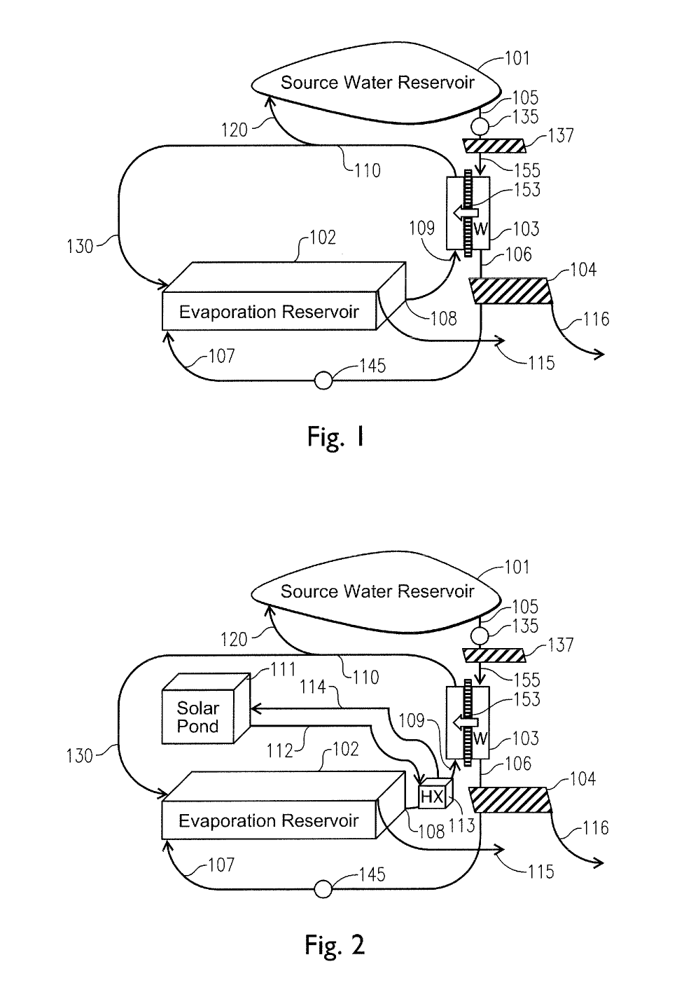

A system 100-2, which is similar to the system of FIG. 1 in many respects, is depicted in FIG. 2. Components of the system 100-2 shown in FIG. 2 that are the same as respective components of the system 100-1 shown in FIG. 1 have the same respective reference numerals and are not described further except as noted below.

The system 100-2 of FIG. 2 includes a solar pond unit 111 and a heat exchanger unit 113 installed on the conduit delivering water from the hypersaline water reservoir 102 to the upstream forward osmosis unit 103. FIG. 2 shows the heat exchanger unit 113 being supplied with hypersaline colder water 108 and a hypersaline hotter water 109 leaving the heat exchanger unit 113 and entering the receiving side of the upstream forward osmosis unit 103. Similarly, hot hypersaline water 112 from the solar pond unit 111 enters the hot side of the heat exchanger 113, which transfers heat to the hypersaline stream 108, and colder solar pond water 114 leaves the heat exchanger and flows back into the solar pond 111.

In at least one embodiment, some hypersaline hot water 112 from the solar pond 111 may be discharged, inside the heat exchanger 113, into the hypersaline water 109 entering the upstream forward osmosis unit 103; thus, making the hypersaline stream 109 hotter and potentially more concentrated.

Because temperature and pressure can affect the flux of water passing from the source feed side 105 to the hypersaline water 109 in the forward osmosis unit 103, the addition of the combined solar pond unit 111 and heat exchanger unit 113 may enhance the concentration process of the source water 105 and therefore is advantageous.

### Third Embodiment of the Invention

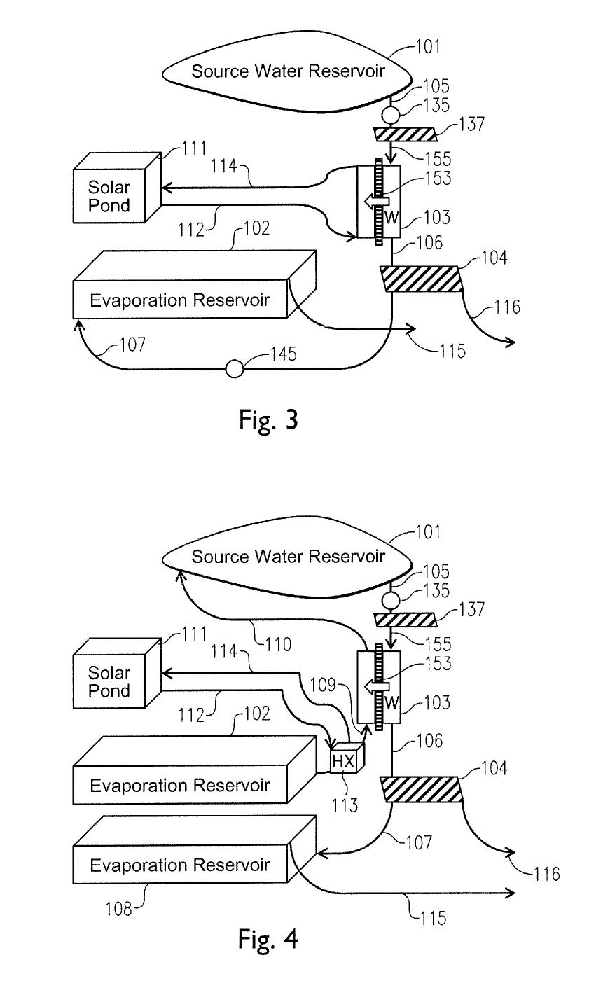

A system 100-3 is illustrated in FIG. 3. Components of the system 100-3 shown in FIG. 3 that are the same as respective components of the system 100-1 shown in FIG. 1, or the system 100-2 shown in FIG. 2 have the same respective reference numerals and are not described further except as noted below. The system of FIG. 3 will be described in conjunction with components of the system of FIG. 2, but could be used in other systems, including the system of FIG. 1.

The system 100-3 of FIG. 3 does not include a heat exchanger on the conduit delivering hypersaline water from the evaporation reservoir 102 to the upstream forward osmosis unit 103, nor does the forward osmosis unit 103 fed on the receiving side of the forward osmosis unit 103 by a hypersaline stream (109 in FIGS. 1 and 2). Instead, hypersaline hot water 112 from the solar pond 111 is used as the draw solution on the receiving side of the upstream forward osmosis unit 103. Hot hypersaline stream 112 enters the forward osmosis unit 103 on the receiving side of the forward osmosis unit 153. Water from the source water 105 having lower salinity diffuses through the forward osmosis membrane 153 and dilutes the hypersaline water 112 entering the forward unit 103. The hot hypersaline water 112 leaving the forward osmosis unit 103 is diluted and at a colder temperature.

### Fourth Embodiment of the Invention

A system 200 is illustrated in FIG. 4. Components of the system 200 shown in FIG. 3 that are the same as respective components of the system 100-1 shown in FIG. 1, or the system 100-2 shown in FIG. 2 have the same respective reference numeral and are not described further except as noted below. The system of FIG. 4 will be described in conjunction with components of the system of FIG. 2, but could be used in other systems, including the system of FIGS. 1 and 3.

The system 200 of FIG. 4 includes a downstream evaporation reservoir 108 to accept concentrated (and hypersaline) source water 107 after concentration in the upstream forward osmosis unit 103 and solid separation unit 104. Hypersaline water 109 is drawn from the upstream hypersaline evaporation pond 102 and enters the forward osmosis unit 103 on the receiving side of the forward osmosis membrane 153. Pretreated source water 155 enters the forward osmosis unit 103 on the feed side of the forward osmosis membrane 153 and diffuses through the semipermeable forward osmosis membrane 153 into the hypersaline stream 109. Concentrated source water 106 may further undergo solid separation in the solid separation unit 104 and flow into downstream evaporation reservoir 108.

By using two or more evaporation reservoirs, unneeded hypersaline water from the one or more reservoirs 102, 108 can be beneficially used as an energy source to extract water, and therefore, concentrate source water 105 before discharging the spent hypersaline water 110 back into the source water reservoir 101.

### Examples

The following examples set forth preferred methods in accordance with the invention. It is to be understood, however, that these examples are provided by way of illustration and nothing therein should be taken as a limitation upon the overall scope of the invention.

### Summary

Forward osmosis experiments were conducted with a Great Salt Lake (“GSL”) water feed solution and with concentrated MgCl₂ draw solution. The draw solution was prepared with pelleted MgCl₂ salt from the GSL. HTI-CTA and OASYS-TFC membranes (obtained from HTI, Scottsdale, Ariz., and OASYS Water, Boston Mass., respectively) were used in the experiments.

Sets of experiments were conducted with different feed and draw solution temperatures (10° C., 20° C., and 40° C.) to simulate the effects of weather and/or operating conditions on the performance of the process. Most experiments were conducted with an initial feed volume of 6 L filtered GSL water. The initial draw solution volume in the experiments was 1 L, 2 L, or 3 L. Experiments with turbulence enhancement spacers were also conducted in order explore the effects of feed and draw solutions mixing on process performance. All experiments were terminated when water flux reached 1 L/m²-hr (LMH).

Results from these experiments revealed that initial water flux increases with increasing temperatures. It was also revealed that the higher initial volume of draw solution resulted in longer run times and higher concentration factors of the GSL feed water. In addition, results demonstrated that when using turbulence enhancing spacer the initial water flux increases.

Experiments with the HTI-CTA membrane were conducted with and without spacers. The temperature was kept at 10° C., 20° C., or 40° C. The initial feed solution volume was 6 L, and the initial draw solution volume was 1 L, 2 L or 3 L. The initial concentration of the MgCl₂ draw solution was approximately 350 g/L, and the initial feed concentration was approximately 150 g/L TDS. The average compositions of the draw and feed solutions are summarized in Table 1.

TABLE 1
Average composition of draw and feed solutions

| | AVERAGE DRAW | |
|---|---|---|
| | SOLUTION | AVERAGE FEED SOLUTION |
| ION | (in mg/L, per ~350 g/L) | (in mg/L, per ~150 g/L) |
| Al | 22 | 11 |
| B | 448 | 0.0 |
| Ca | 3,281 | 339 |
| K | 578 | 3,044 |
| Li | 599 | 25 |
| Mg | 62,538 | 5,135 |
| Na | 3,459 | 44,705 |
| Cl | 263,396 | 96,489 |
| Br | 1,190 | 139 |
| SO₄ | 803 | 21,965 |

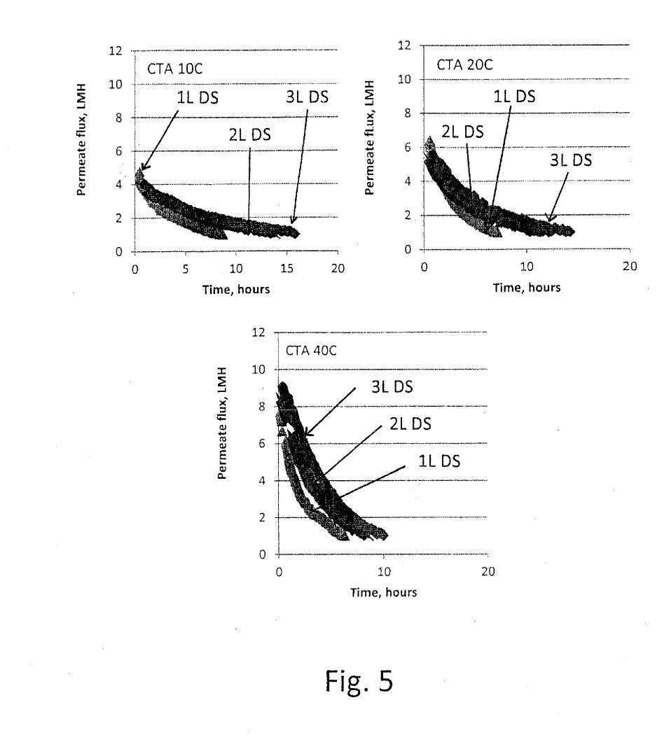

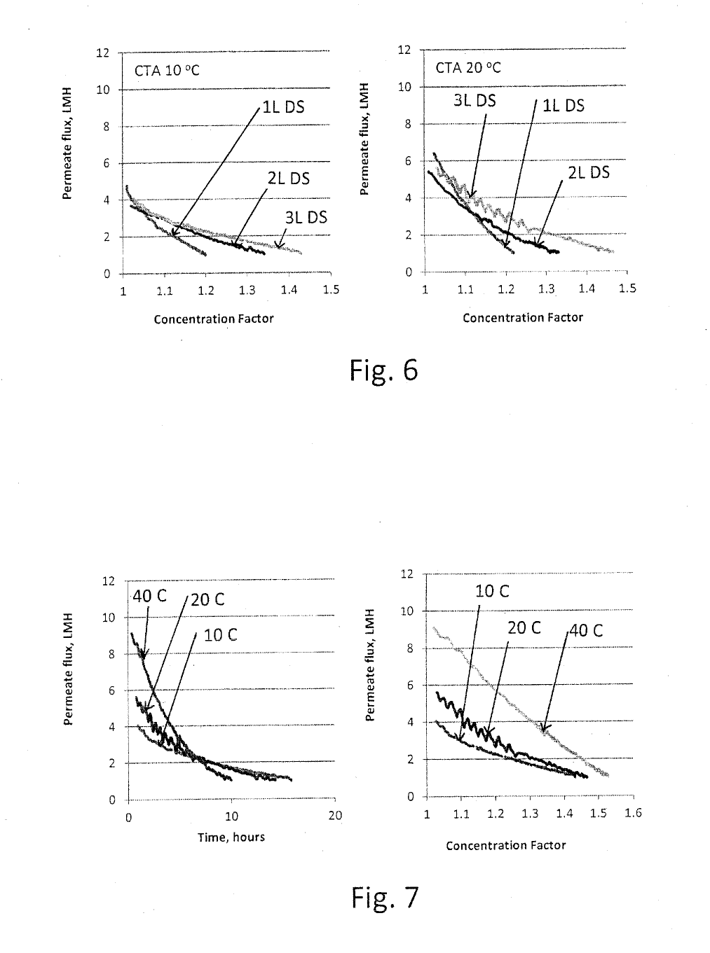

The water flux as a function of time is shown in FIG. 5, while the water flux as a function of concentration factor is shown in FIG. 6. The water flux as a function of both time and concentration factor is shown in FIG. 7 (initial draw solution volume was 3 L).

Referring to FIG. 8, the water flux as a function of time and concentration factor is shown (again initial draw solution volume was 3 L), but with these experiments conducted with turbulence enhancer spacers in the flow channels.

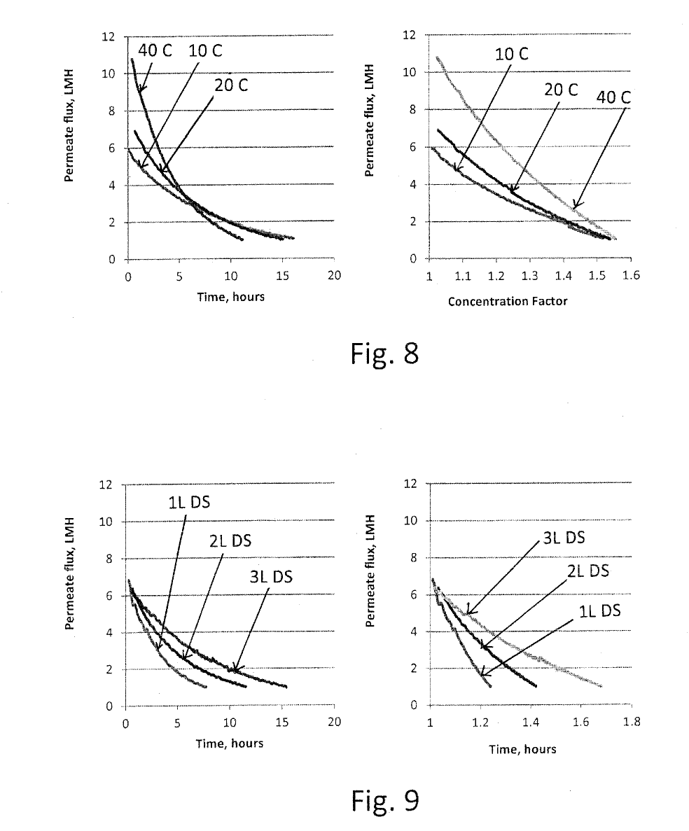

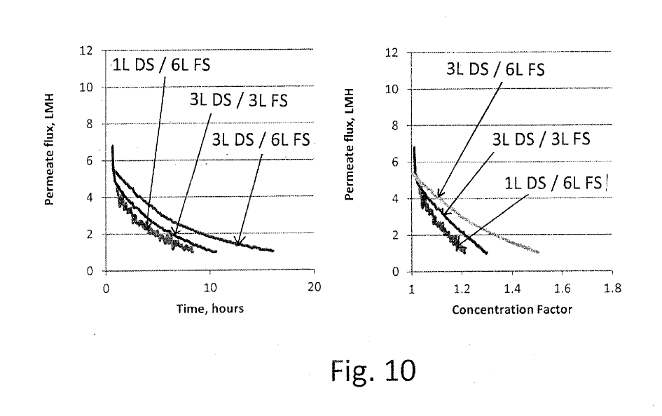

Finally, the above experiments were repeated with an OASYS-TFC membrane at 20° C., and that water flux as a function of time and concentration factor is shown in FIG. 9. The OASYS-TFC membrane was tested again, but changing the temperature to 10° C. (see FIG. 10).

We claim:

1. A method of recovering solids from an aqueous source, said method comprising:
providing a forward osmosis unit comprising:
a feed chamber having an inlet and an outlet;
a draw chamber having an inlet and an outlet; and
a semipermeable membrane positioned between the feed and draw chambers, said membrane having a permeate side in communication with the draw chamber, and a feed side in communication with the feed chamber;
passing:
source water through said feed chamber; and
a draw solution through said draw chamber, said passing causing water from said source water to be drawn through the membrane and into the draw solution, so that a concentrated source water exits from the feed chamber outlet and a diluted draw solution exits from the draw chamber outlet; and
carrying out one or more of the following:
(a) recovering solids from said concentrated water source;
(b) extracting energy from said concentrated water source; and
(c) returning said diluted draw solution for reuse as a draw solution.

2. The method of claim 1, wherein (a) is carried out in a device selected from the group consisting of gravity clarifiers, hydrocyclones, filtration devices, settling ponds, solar evaporation ponds, evaporative crystallizer tanks, and vacuum-cooled crystallizer tanks.

3. The method of claim 1, wherein (a) is carried out, and the solids that are recovered include those selected from the group consisting of salts.

4. The method of claim 1, wherein said source water is selected from the group consisting of brackish water, impaired water, wastewater, chemical processing streams, sea water, lake water, solar pond water, and reservoir water.

5. The method of claim 1, wherein said draw solution comprises osmotic agents selected from the group consisting of sulfate salts, chloride salts, and mixtures thereof.

6. The method of claim 1, wherein said the flux of said water through said membrane is from about 1 L/m²-hr to about 15 L/m²-hr.

7. The method of claim 1, further comprising increasing the temperature of said draw solution prior to said passing through the draw chamber.

8. The method of claim 7, wherein said heating comprises passing said draw solution through a heat exchanger.

9. The method of claim 8, wherein said heat exchanger receives heated water from a solar pond and uses said heated water to increase said draw solution temperature.

10. The method of claim 1, wherein (a) is carried out, yielding an aqueous solution after solids recovery, further comprising returning transferring said aqueous solution to an evaporation reservoir.

11. The method of claim 1, further comprising pretreating said source water prior to passing through said feed chamber, said pretreating being a process selected from the group consisting of evaporation, coagulation, media filtration, microfiltration, ultrafiltration, beach wells, ion-exchange, chemical addition, and disinfection.

12. The method of claim 1, wherein (b) is carried out, but further comprising, prior to (b) being carried out, subjecting the concentrated water source to an energy recovery process.

13. The method of claim 12, wherein said energy recovery process comprises subjecting the concentrated water source to a device selected from the group consisting of heat-exchanger, circulators, radiators, boilers, and power exchangers.

14. The method of claim 1, wherein said semipermeable membrane comprises a plurality of membranes connected in parallel or series.

15. A solids recovery system comprising:
a forward osmosis unit comprising:
a feed chamber having an inlet and an outlet;
a draw chamber having an inlet and an outlet; and
a semipermeable membrane positioned between the feed and draw chambers, said membrane having a permeate side in communication with the draw chamber, and a feed side in communication with the feed chamber;
a source water source in communication with the feed chamber inlet;
a draw solution source in communication with the draw chamber inlet;
an evaporation reservoir in communication with the draw chamber outlet; and
a solids separation device in communication with the feed chamber outlet.

16. The system of claim 15, wherein one or both of said draw solution source and evaporation reservoir comprise a solar pond.

17. The system of claim 15, further comprising a second evaporation reservoir in communication with said solids separation device.

18. The system of claim 15, wherein said solids separation device is selected from the group consisting of gravity clarifiers, hydrocyclones, filtration devices, settling ponds, solar evaporation ponds, evaporative crystallizer tanks, and vacuum-cooled crystallizer tanks.

19. The system of claim 15, wherein said source water source is selected from the group consisting of a sea, lake, solar pond, and reservoir.

20. The system of claim 15, further comprising a pretreatment unit between and in communication with said source water source and said forward osmosis unit, said pretreatment unit being selected from the group consisting of evaporation devices, coagulation devices, media filtration devices, microfiltration devices, ultrafiltration devices, beach well devices, ion-exchange devices, chemical addition devices, and disinfection devices.

21. The system of claim 15, wherein said semipermeable membrane comprises a plurality of membranes connected in parallel or series.
